(19) United States
(12) Patent Application Publication
(10) Pub. No.: US 2010/0275130 A1
(43) Pub. Date: Oct. 28, 2010

(54) APPLICATION PERSONAS

(76) Inventor: Patrick Thomas McBride, Salt Lake City, UT (US)

Correspondence Address: KING & SCHICKLI, PLLC, 247 NORTH BROADWAY, LEXINGTON, KY, 40507, US

(21) Appl. No.: 12/428,688

(22) Filed: Apr. 23, 2009

(51) Int. Cl. G06F 3/00

(52) U.S. Cl. 715/751

(57) ABSTRACT

Apparatus, methods and computer program products relate to utilizing a plurality of personas for a single user in a computing application. As such, the user can conveniently and quickly switch between personas while editing a document, for example, and tracking actions under all personas enables simultaneous or separate visual display so users can quickly spot differences in their own work, not just the work of a separate user. Various features include persona creation and settings per each persona distinguishable from other personas. Creation of personas can occur during installation or upon selection of options. Settings include colors for editing functions and formatting for insertions like underlining. Detecting a switch in personas is another feature as is event logging. Persona switching occurs via icon or menu selection. Optionally, security features also authenticate users.

### FIELD OF THE INVENTION

Generally, the present invention relates to computing applications for users of one or more computing devices to undertake tasks such as word processing, creating a presentation, filling out forms, etc. Particularly, although not exclusively, it relates to utilizing the applications with multiple personas per a single user to achieve a variety of useful results. Various features include persona creation, settings per each persona, detecting switches in personas, event logging and security, to name a few.

### BACKGROUND OF THE INVENTION

Computing applications have been known for some time to help users perform computing tasks, such as the above-mentioned word processing, creating a presentation, filling out forms, etc. In a typical application, users first “logon” to the computing device having the application installed, or to a device having access to the application, then “open” the application and use it for its intended purpose. Regardless of form, contemporaneous and older computing applications are destined for use with registered users typically identified during application installation. In that users often have many “roles,” such as in a personal context or in an identity-managed computing environment in an employer's business (e.g., father, coach, manager, employee, director, system administrator, etc.), they regularly have need or desire to act in those roles when using local computing applications or visiting company resources, such as server-based computing applications.

For instance, a user in the role of manager may need to access company-based computing applications to learn or investigate the financial pay information and benefits for direct-reporting employees. The same user may also have need to investigate the same application when in the role of employee to learn or investigate their own financial pay information and benefits. For at least this reason, the same user has multiple roles and multiple needs of visiting a common application. Yet, existing applications fall short of accommodating this need. Also, it is important for the user to understand what role they are behaving in because inconvenience results if applications are visited when in the wrong role. That is, users need to re-verify credentials or re-login, such as with username and password, to visit the application or website in a role different than their existing role, and this causes inconvenience.

As another example, consider a two-sided negotiation over a contract. Users on both sides of the contract, such as in the role of lawyers, mark up drafts of the contract with proposed changes, trading the document back and forth until the panics come to an agreement. In some cases, it would be useful to know whether changes proposed by the same lawyer, the same registered user of the computing application, were made three days ago or, say, three months ago. For example, if the parties met three days ago to discuss a royalty rate, and came to agreement on that topic, a lawyer representing one of the parties would likely mark up the draft contract to reflect the agreed-upon royalty rate and send it to the other side for review.

However, if the draft contract already contained changes proposed three months ago by the same lawyer that are still under review by the other side, the lawyer faces a dilemma. He can add the new changes to the document, but in that case the new changes made by the lawyer will be marked up in word processor applications, such as Microsoft's Office or OpenOffice Writer, in a manner that is indistinguishable from the changes he proposed three months before. In other words, the entirety of changes by a single user appear the same regardless of when entered, e.g., they show up as underlined red text, and the other side will have difficulty immediately distinguishing the old unaccepted proposals (i.e., those from three months ago) from the new agreed-upon changes (i.e., those from three days ago). Intuitively, that form of negotiation needlessly slows down resolution and creates burdensome and expensive legal work on both sides of the negotiation.

Alternatively, the lawyer could accept or reject all of the old changes, such as with a track-change function, and then make the new changes. While this would have the advantage of clearly identifying only the new changes for the other party, it would have the disadvantage of creating a draft that errs either on the side of failing to reflect all changes proposed by one side, or on the side of inappropriately reflecting non-existent agreement on such proposed changes. In complex negotiations, such things are important to avoid.

Alternatively still, the lawyer could create another registered user account on his computing device, and login as that other user. When changes are then made in the draft contract, he would be automatically identified as a user different from the original user, thus distinguishing settings (i.e., underlining format, editing colors, balloon commenting, etc.) and clearly differentiating the old proposed changes from the new changes. But this has the disadvantage of requiring the lawyer to create a new account, log out, log back in under the other user name, etc. This is overly complex.

Accordingly, there is need in the art of computing applications for users to engage functionality in many different roles or personas. There is further need to do so in the context of a clear delineation between all roles or personas. It is also important that the foregoing be available conveniently, including mechanisms to change roles or personas in real time. In that many users already own and/or use favorite computing applications, it is further desirable to retrofit or convert existing applications to the type meeting the needs outlined above. Naturally, any improvements along such lines should further contemplate good engineering practices, such as stability, ease of implementation, high security, flexibility, etc.

### SUMMARY OF THE INVENTION

The foregoing and other problems become solved by applying the principles and teachings associated with the hereinafter-described application personas. At a high level techniques implement persona-based control over computing applications for convenient and quick switching between personas to effectuate changes in a computing application that are visually useful to the user. In a word processing computing application, for example, pluralities of personas each have distinguishable settings, such as different editing colors and insertion formats, and processing tracks actions under all personas for simultaneous or separate visual display, including the different colors and formats. In this manner, users can quickly spot differences in their own, edited work, not just the edited work or comments of a separate, other user.

Persona creation occurs in a variety of ways, but is available during installation of the application or upon selection of certain options. Detecting a switch in personas is another feature so the application can accurately effectuate changes in the attendant settings of a given persona. It also assists in event logging for later reconstruction. Persona, switching can occur in a variety of methodologies, but icon and menu selection are two such options. When in icon form, icons may suggest roles or status of users.

Security features are also contemplated to authenticate users when application usage involves sensitive, confidential or secret, etc., material. In terms of security, however, a basic assumption exists that a user who has a legitimate right to operate in a computing application is not malicious and will not misuse his or her own privileges. Nevertheless, the invention is mindful of the desirability of discouraging and/or monitoring the unauthorized use of personas, and certain security features become optional characteristics.

In a computing system environment, the invention may be practiced on one or more of a variety of stand alone or connected computing devices (physical or virtual), e.g., general or special purpose computers, PDAs, phones, servers, etc. Computer program products are also disclosed as executable code on readable media, as a download, etc. They may entirely or partially install the functionality of application personas on one or more of the computing devices and/or retrofit existing application products.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1-3 are diagrammatic views in accordance with the present invention of a representative computing application having a variety of personas, including utilization thereof;

FIG. 4 is a diagrammatic view in accordance with the present invention of a representative computing application having a variety of personas, including an alternate display;

FIGS. 5A-5D are diagrammatic views in accordance with the present invention for creating personas for a computing application, including creating persona settings;

FIGS. 6 and 7A-7B are diagrammatic views in accordance with the present invention for alternately creating personas for a computing application;

FIG. 8 is a diagrammatic view in accordance with the present invention for switching personas in a tracking change function in a representative word processing embodiment of a computing application;

FIGS. 9A and 9B are diagrammatic views in accordance with the present invention for logging or auditing events in a representative computing application having a variety of personas;

FIG. 10 is a diagrammatic view in accordance with the present invention of a representative computing application having a variety of personas, including a security application;

FIG. 11 is a flow chart in accordance with the present invention of a high-level utilization for computing applications having personas; and

FIG. 12 is a diagrammatic view in accordance with the present invention of a representative computing environment including computing devices utilizing installed or accessible computing applications having a variety of personas.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, arrangement, computing software and/or other changes may be made without departing from the scope of the present invention. In accordance with the present invention, methods, apparatus and computer program products for computing applications having personas are hereinafter described.

Also, to illustrate certain features, a common working example will be used throughout the many figures. Namely, a computing application will typify a word processing computing application whereby users undertake tasks such as document creation, document editing, etc. In a first persona, an “original author” provides typing or text attempting to present the well known pangram “The quick brown fox jumped over the lazy river.” Since the word “river” should be “dog” instead, the mistake is noticed some time after the user's original creation and a second persona, “editor,” fixes the mistake. As will be seen, the problems of the background section are overcome. This includes providing a single user with a plurality of personas, each with their own settings, so they can switch conveniently and easily between personas (and their attendant settings) to provide efficacious, different visual displays so users can quickly spot differences in their own work, not just the work of a separate user. As skilled artisans will readily imagine, other computing applications can be used instead of word processing applications and other personas will provide additional benefit. Improvement will also be noticed as the task of the computing application becomes more complex, instead of simply typing a pangram which is later edited.

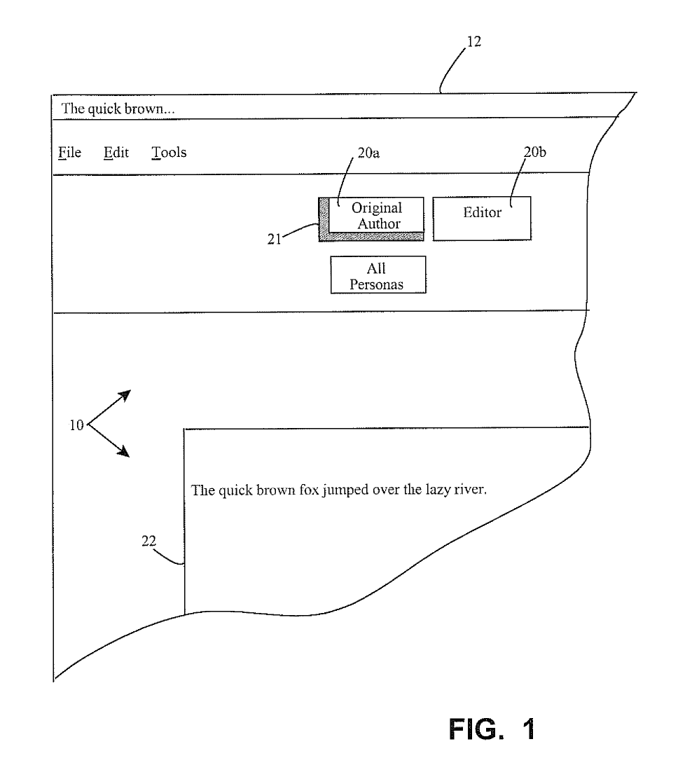

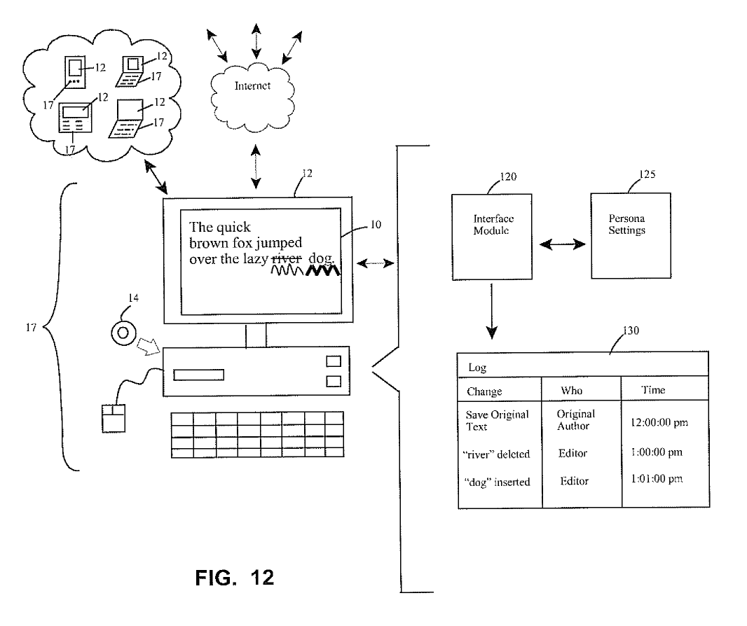

In more detail FIG. 1 shows a computing application 10 on a viewable screen 12 of a computing device. The application is installed on the computing device, such as in firmware or in local or remote memory, and/or is accessible by the computing device, such as from an enterprise server or the Internet. In either, the application embodies a computer program product having executable instructions available on a readable media, e.g., disk 14 for insertion in a drive of a computer device 17, FIG. 12, available in firmware of the computing device, and/or available for installation as a download from an upstream, networked, peer, etc. computing device or readable media. Naturally, the program product could include the entirety of the computing application or only relevant portions, such as in the context of a retrofit to convert existing applications or for piecemeal installation. Also, skilled artisans will understand that such program products have various modules, routines, programs, objects, components, data structures, etc., that perform particular tasks or implement particular abstract data types within various structures of the computing device which cause certain functions to occur as users of the product undertake tasks.

Regardless of form, one or more personas 20a, 20b exist per a single user of the application and each have settings indicative of that persona. For instance, the original-author persona might have a wavy-line underlining format selected to indicate insertions into the word processing document 22 and a color red selected to show editing functions. The editor persona, on the other hand, might have a triangular underlining format with a blue color. Visually, both contrast one another so users can quickly spot differences in their work.

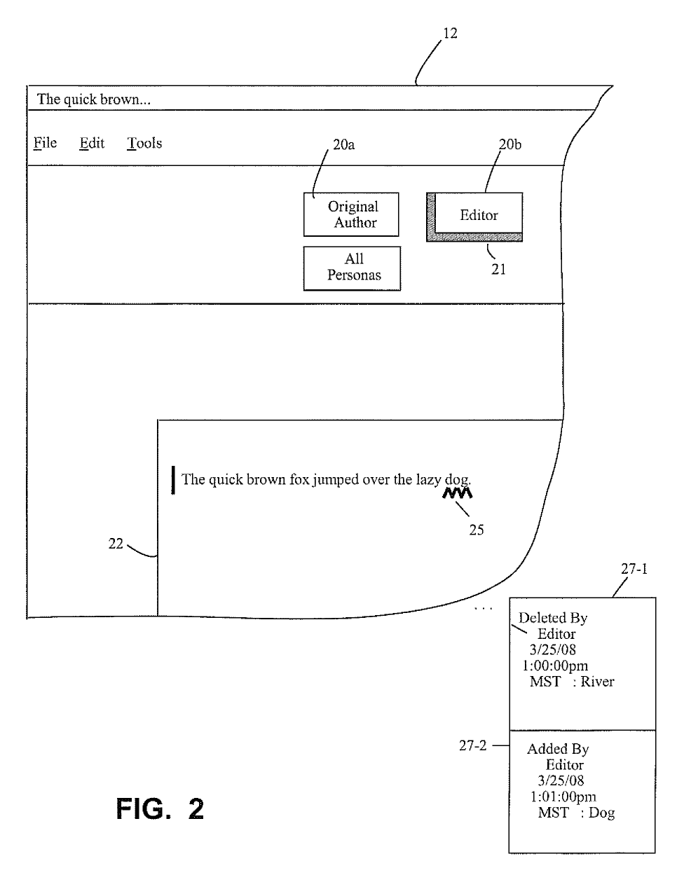

As seen, the text “The quick brown fox jumped over the lazy river” is entered into a typing space of the word processing application under the persona labeled the “original author.” Because it was later noticed that the word “river” should be “dog” instead, the same user wants to make the correction to the pangram, but wants to make corrections that can be tracked relative to the original work. Thus, the use of the second persona. In FIG. 2, this is seen as the word “river” being replaced with the word “dog,” and such is highlighted with settings corresponding to the second persona (editor), including a triangular underline 25 and blue color. Also, balloon comments 27-1, 27-2 indicate the differences in the computing application as was entered under the different personas.

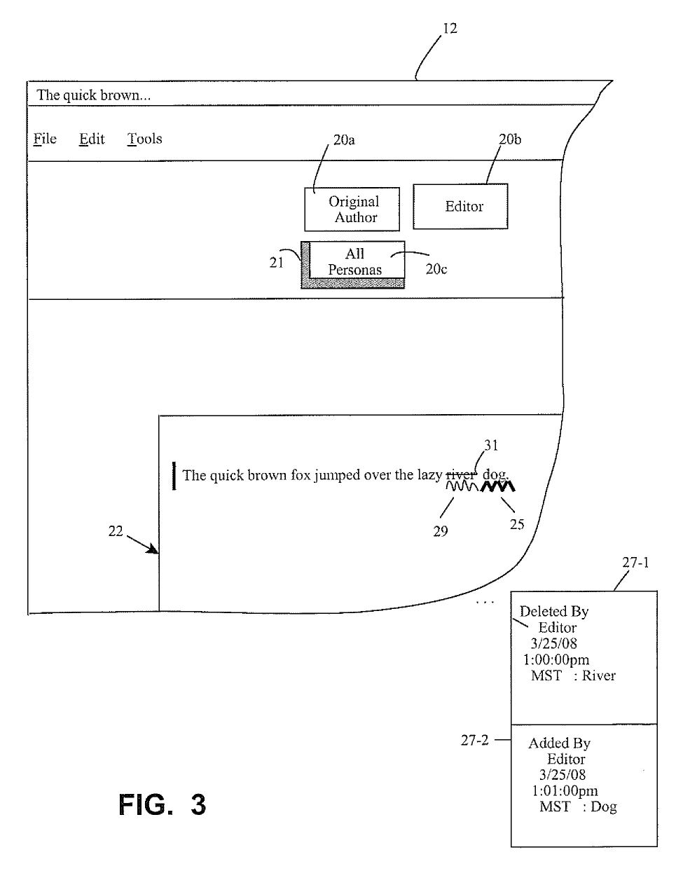

In another embodiment, it will be appreciated that a different visual cue to users exists in the form of simultaneously showing all applications of persona settings to a user, instead of doing so separately. Thus, FIG. 3 shows all contributions and effects on the word processing document 22 under all personas 20c. Namely, the original triangular underline 25, in blue color, for the editor persona still exists, as does the wavy-underline 29 and strikeout 31, both in red color, per the settings of the original-author persona.

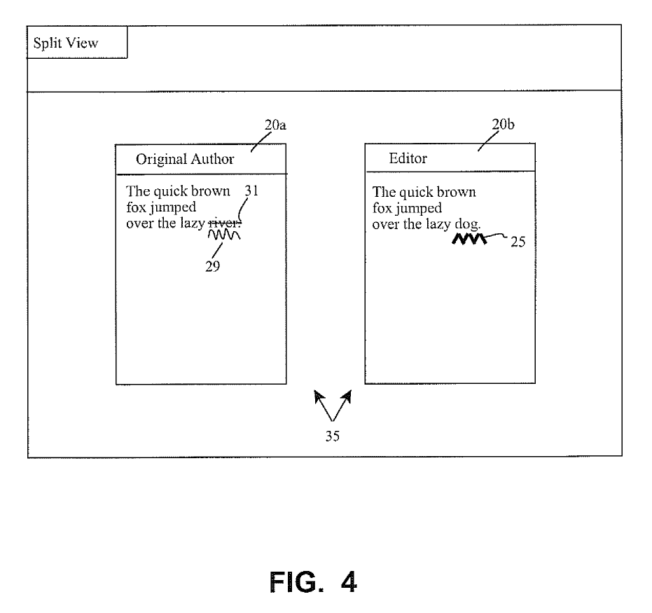

Alternatively still, FIG. 4 teaches that the entirety of the user's personas could be viewed simultaneously, but in a side-by-side format 35. Thus, again, providing advantage over the art by giving visual cues so users can quickly spot differences in their own work, not just spotting visual cues between themself and the work of a separate user.

In any embodiment, it is appreciated users may be initially unfamiliar with the meaning of personas, so further functionality is contemplated in the form of mouse-over gestures to provide the user with a tool tip. Other embodiments also contemplate attention cues with or without aural cues, such as icon or persona settings that blink, beep, gray-out, etc. and such further indicates dynamic separation of personas.

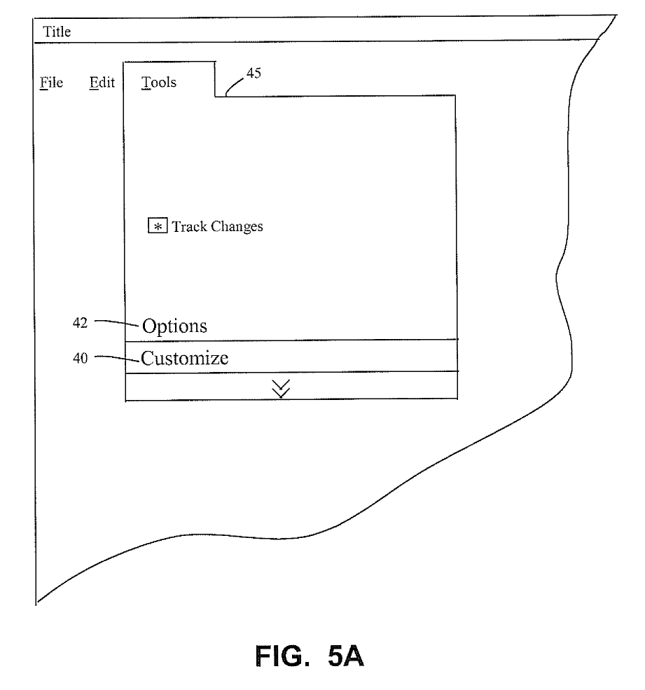

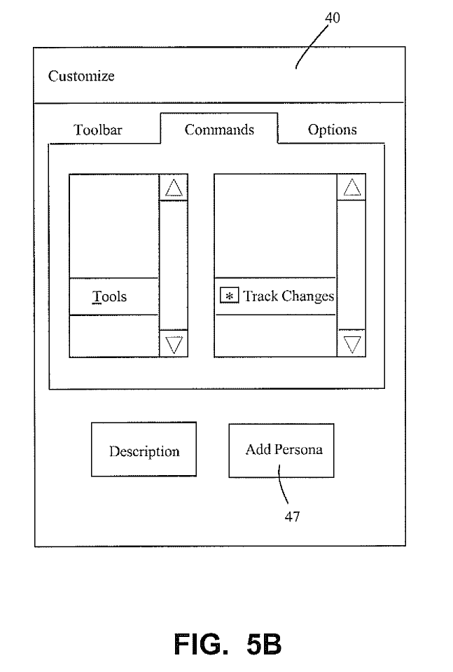

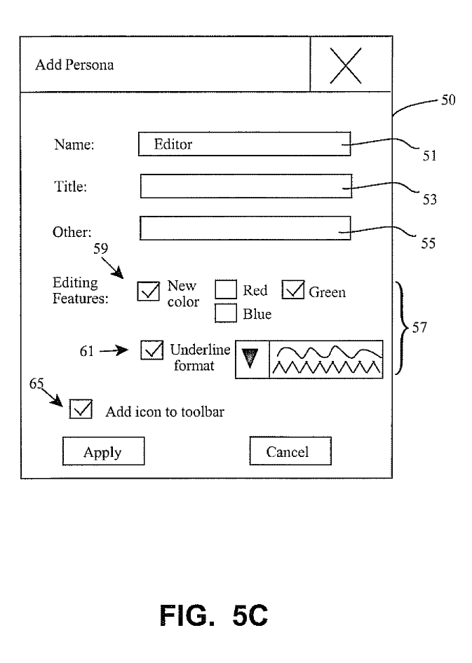

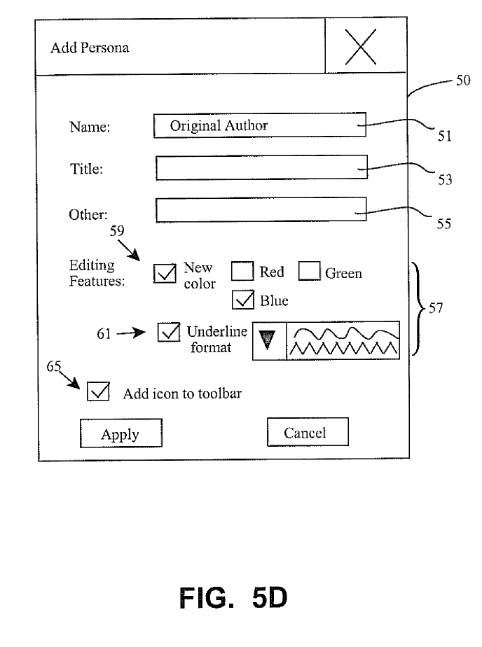

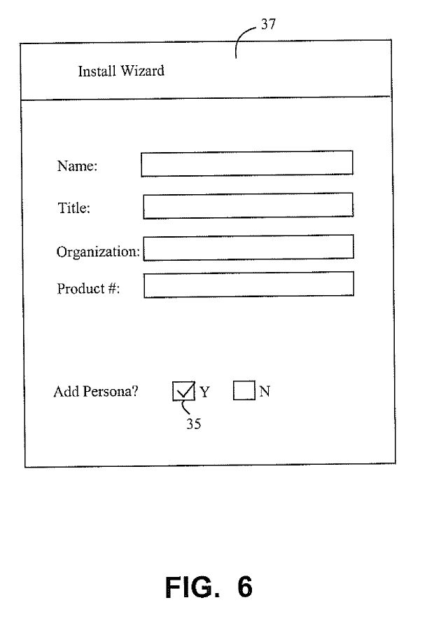

To create a persona, it is contemplated that such will occur at convenient times such as during installation of the computing application on a computing device, or as-needed by selecting a menu option. For the former, it is contemplated that users will be able to indicate their preference for personas during installation, such, as by checking a box 35 during execution of an installation wizard 37, FIG. 6. For the latter, it is contemplated that users will select a menu option (e.g., “customize” 40 or “option” 42), such as under an application's “Tools” menu 45. FIG. 5A. In turn, another box-checking event is produced or entry of personas occurs by way of selecting a button 47, FIG. 5B.

In either, FIGS. 5C and 5D contemplate application pop-up dialogs 50 whereby users fill out persona information (such as name 51, title 53, or other information 55) and make setting 57 selections per each persona that correspond thereto. For instance, a user in a word processing computing application has the option to select a color 59 for editing a word processing document and an insertion function, such as an underlining format 61. Of course, skilled artisans will readily contemplate other settings in this and other types of computing application. Also, a user may have further options, such as adding an icon 65 representing or corresponding to their personas in a tool bar of the computing application. In such instances, it is anticipated that the icon will consist of word(s), letter(s), symbol(s), etc., including colors or not, directly indicative of the personas of the user or suggestive of same.

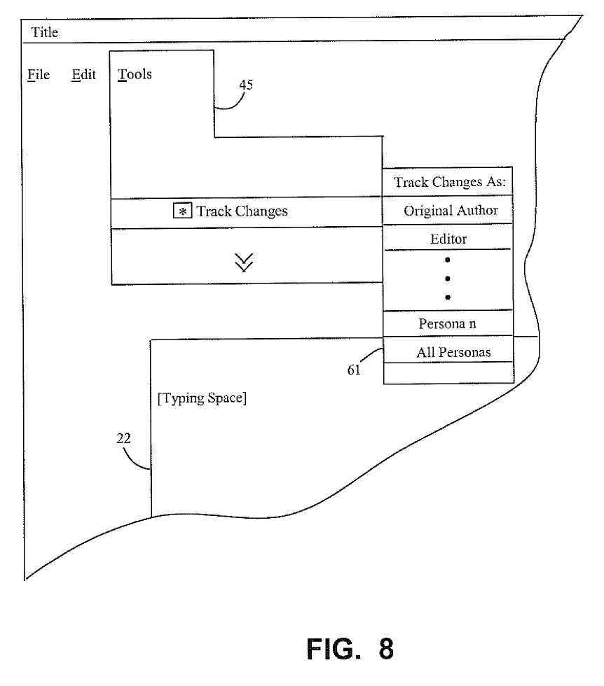

During use, users merely switch between their personas by selecting one or another of the appropriate icons, such as 20a, 20b, 20c in FIGS. 1-3. Active icons in the tool bar can be indicated positively to the user by use of shadowing 21, FIGS. 1-3, or other methods. In an alternate technique, FIG. 8, users switch between personas by selecting personas from a menu option, such as “All Personas” 61 in the Tools menu 45.

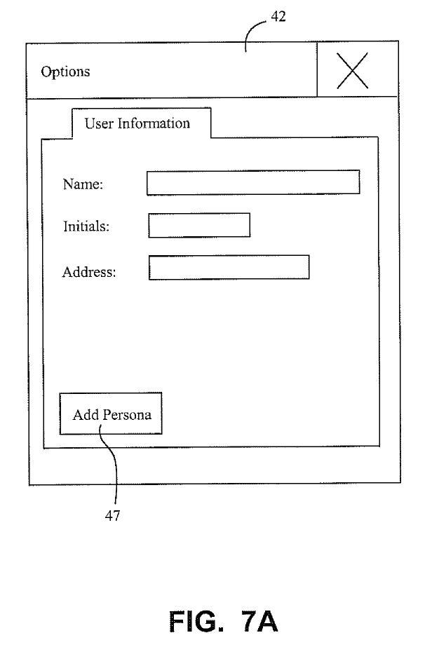

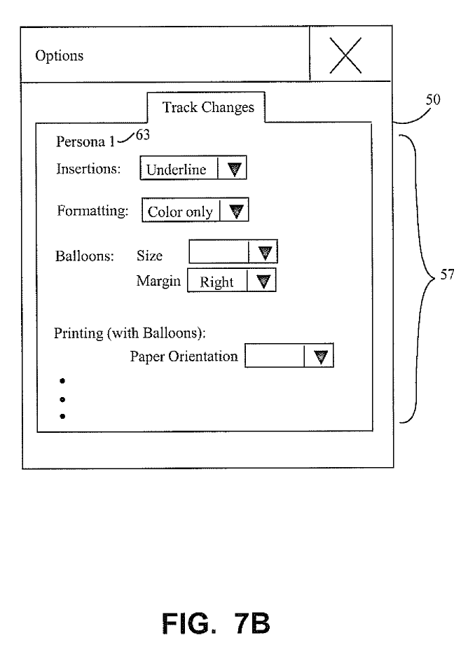

In an alternate embodiment for persona creation, FIGS. 7A and 7B show a scenario implemented upon selection of the “options” feature 42 of the “Tools” menu 45 in FIG. 5A. Namely, another button 47 could be selected which creates another pop-up dialog 50 with a whole host of other settings 57′ that are selectable per a given persona 63.

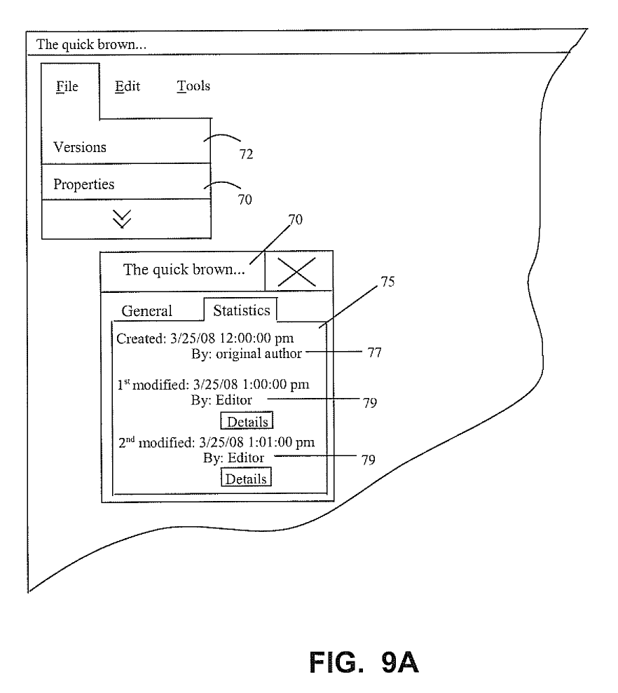

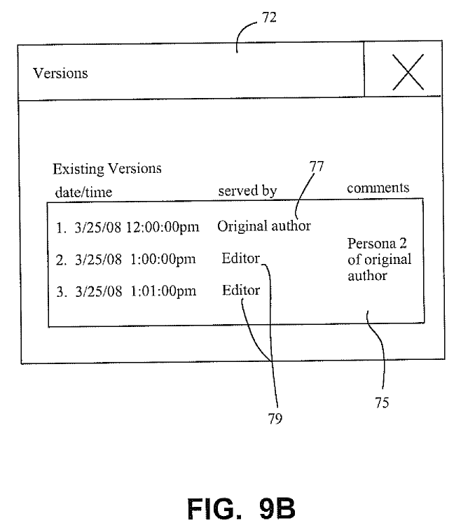

With reference to FIGS. 9A and 9B, logging or auditing events are captured to provide further user functionality, including logging according to each of the user's personas. Namely, a “properties” 70 or “versions” 72 pop-up dialog box can give relevant information or statistics 75 about events occurring during application of one persona 77 versus another 79. In a representative form, such events can be date/time stamps about changes in a word processing document, comments, which persona entered the changes, when did the user change personas, etc.

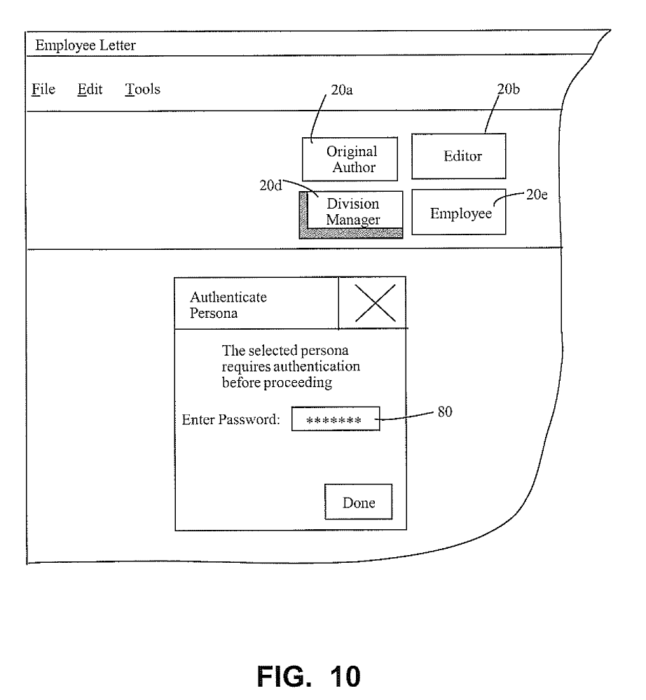

In FIG. 10, it will be appreciated that certain personas may require authentication due to the sensitive nature of underlying content or for other reasons, such as a policy of an enterprise that only allows division managers to access a payroll computing application on behalf of employees other than themself. As such, upon selection or switching to a persona of this type, e.g., persona 20d-Division Manager, a security measure is invoked. In this instance, a pop-up dialog requires entry of a password 80 before the computing application can be used. On the other hand, if the user switches their employee persona 20e, direct access to the payroll application is allowed without invocation of security or authentication of the user. Events related to logging, e.g., FIGS. 9A and 9B, can also be useful in the security context to reconstruct a timeline of events to uncover abuses in policy, denied authentication of users, etc.

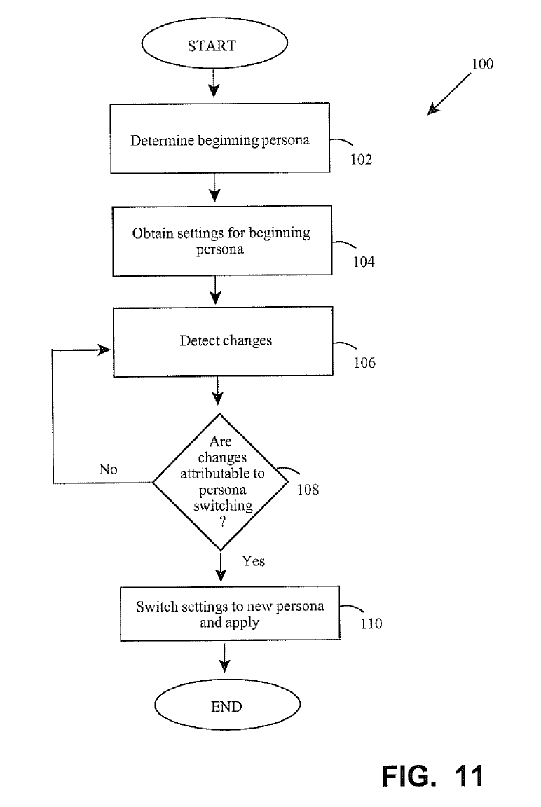

In FIG. 11, a utilization of personas in computing applications is given generally as 100. At step 102, a beginning persona is determined, such as upon a user or system administrator setting a default or primary persona that is invoked upon the opening of an application. In turn, its settings to effect change on the computing application, e.g., editing colors, insertion functions, etc., are obtained at step 104. Then as changes occur in the computing application, they are detected at step 106. In this regard, changes could be monitored in a word processing computing application by monitoring an “undo” log or by hashing files to determined differences from one version to a next, or by other known or later discovered means. They could also be determined by assessing whether various persona icons 20, FIGS. 1-3 were selected in lieu of another icon or by way of an entry in the track change functionality in FIG. 8. Regardless, if the detection of changes in the computing application are attributable to a change in persona, step 108, the settings corresponding to the beginning persona are then switched to the settings of the newly selected persona, at step 110, and applied to the computing application. Conversely, if the detected changes at step 108 are not related to switches in personas, the process repeats until such time as a persona change is detected.

In FIG. 12, computing device(s) 17 and/or the computer program product aspect of the invention implements the flow of FIG. 11, including an interface module 120, a persona settings module 125 and the mechanism to detect changes in personas, in this case an “undo” log 130. In more detail, the interface module takes user input in the form of persona creation and arranges its corresponding settings 125 in memory for eventual application to the computing application. Also, it learns of changes in the computing application, and logs such events at 130. Upon a switch in personas, e.g., a switch between the original author persona and the editor persona at 1:00:00 p.m., the settings from 125 are obtained for the editor persona and are used in the computing application in lieu of the settings for the beginning persona, i.e., the original-author persona.

Preceding usage, however, typical events for applications include a user logging onto a computing device. As is known, this may consist of a user filing out and submitting forms, such as those associated with log-on/log-in screens having usernames and passwords, or may occur by way of simple operation of the computing device. That is, computing devices themselves are sometimes assigned to users in particular roles in organizations and the mere operation of the computer is enough to recognize the user, in their role, as being logged-on. In this regard, it is also contemplated that logging-on exists in a computing environment whereby users work in different roles inside an organization or entity, such as a corporation, having an innerweb, an intranet, etc., behind a corporate firewall. Upon logging in, a pallette of applications are then available to the users in their role.

For instance, Novell, Inc. (the Assignee of the present invention), provides its employees an innerweb accessible by an employee portal offering secure, personalized access from anywhere in the world. Upon logging-in, the users see and have access to a personalized web site which includes various applications and resources based on their role in the corporation. As described at http://www.novell.com/innerweb/, for example, a user in the role of salesperson has access to comprehensive views and customer information, as well as opportunity and contract management tools. This personalization then prevents employees from having to wade through screens of information to find that which is useful to them in their role. As before, however, users may have multiple roles and therefore have need of knowing their role, such as upon visual curing, to which features of the instant invention are directed. Thereafter, the user opens the relevant computing application for a given task at hand and performs activities in a variety of persona.

Regardless of implementation, certain advantages over the prior art should now be readily apparent. For example, it is heretofore unknown to use personas indicative of different usages of a single user in a computing application. Also, but not exhaustively, personas allow role-based control to be applied to individual portions of content within a larger document, for instance, rather than (or possibly in addition to) exercising access control at the document level, thereby giving fine-grained access control. Personas also fit neatly into SSO environments since they function at the application level, not computer sign-on level. Ultimately, convenient switching of personas provides real time visual cues while a user works in an application and security exists, when necessary, to prevent abuses. Of course, these are only a few of the many advantages of the invention and skilled artisans will immediately recognize others.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of the other figures.

1. A method of utilizing a plurality of personas for a single user in a computing application, comprising:
applying to the computing application one or more first settings of the single user in a first persona of the plurality of personas; and
upon a change in personas from the first persona to a second persona of the plurality of personas, applying to the computing application one or more second settings different from the first settings.

2. The method of claim 1, further including simultaneously displaying effects on the computing application of both the first and second settings.

3. The method of claim 1, further including separately displaying effects on the computing application of the first and second settings.

4. The method of claim 1, further including detecting the change in the personas from the first persona to the second persona.

5. The method of claim 1, further including logging the change in the personas from the first persona to the second persona.

6. A method of utilizing a plurality of personas for a single user in a computing application, comprising:
creating the plurality of personas for the single user for application to the computing application, including creating a plurality of settings for each of the personas;
applying to the computing application the plurality of settings of the single user in a first persona of the plurality of personas;
switching personas from the first persona to a second persona of the plurality of personas; and
applying to the computing application the plurality of settings of the single user in the second persona.

7. The method of claim 6, wherein the creating the plurality of personas occurs during an installing of the computing application on a computing device.

8. The method of claim 6, wherein the creating the plurality of personas occurs upon selection of an option feature of the computing application.

9. The method of claim 6, wherein the switching personas further includes selecting an icon representing one of the plurality of personas.

10. The method of claim 6, wherein the creating the plurality of settings for each of the personas further includes selecting a color for editing functions of the computing application and a format for insertion functions of the computing application.

11. A method of utilizing a plurality of personas for a single user in a computing application, comprising:
receiving an indication of a plurality of personas created for the single user for application to the computing application, including receiving an indication of a plurality of settings created for each of the personas;
applying to the computing application the plurality of settings of the single user in a first persona of the plurality of personas;
determining a switch in personas from the first persona to a second persona of the plurality of personas; and
applying to the computing application the plurality of settings of the single user in the second persona.

12. The method of claim 11, further including causing simultaneous display of effects on the computing application of the plurality of settings for each of the plurality of personas.

13. The method of claim 11, further including causing separate display of effects on the computing application of the plurality of settings for each of the plurality of personas.

14. A method of utilizing a plurality of personas for a single user in a computing application of a computing environment, comprising:
logging the single user onto a computing device of the computing environment;
from the computing device, opening the computing application;
applying to the computing application one or more first settings of the single user in a first persona of the plurality of personas; and
upon a change in personas from the first persona to a second persona of the plurality of personas, applying to the computing application one or more second settings different from the first settings.

15. In a word processing application, a method of utilizing a plurality of personas for a single user, comprising:
receiving an indication of a plurality of personas created for the single user for application to the word processing application, including receiving an indication of a plurality of settings created for each of the personas, the settings including a color for editing a word processing document and an underlining format for insertion underneath words of the word processing document;
applying to the word processing document the color and the underlining format of the single user in a first persona of the plurality of personas; and
applying to the word processing document the color and the underlining format of the single user in a second persona of the plurality of personas.

16. The method of claim 15, further including determining a switch in personas from the first persona to the second persona.

17. The method of claim 15, wherein the receiving the indication of the plurality of personas being created occurs during an installing of the word processing application on a computing device or upon selection of an option feature of the word processing application.

18. A system for utilizing a plurality of personas for a single user in a computing application of a computing environment, comprising:
a computing device with a viewing screen; and
a computing application installed for use with the computing device, the computing application having an interface module for causing a variety of display options on the viewing screen based on one or more of the plurality of personas for the single user and having a color selectable by the single user for editing functions of the computing application and a format for insertion functions of the computing application, the color and format being different for each persona of the plurality of personas.

19. A computer program product available as a download or on a computer-readable medium for installation with a computing device of a user to word process documents, the computing device having a viewing screen, comprising:
a first component configured for receipt of data representing a plurality of personas available to the user in which the user can word process the documents; and
a second component functioning to cause display on the viewing screen of a plurality of settings associated with both a first and second persona of the plurality of personas, the plurality of settings for the first and second persona being different from one another to visual distinguish the personas on the viewing screen.

20. The computer program product of claim 19, wherein the plurality of settings for the first and second component further includes a color selectable by the user for editing functions of the documents and a format for insertion functions into the documents, the color and format being different for each persona of the plurality of personas.

21. The computer program product of claim 19, further including a third component for determining when a switch occurs in personas from the first persona to the second persona.

22. The computer program product of claim 19, wherein the second component is configured to cause on the viewing screen simultaneous display of effects of the plurality of settings for each of the plurality of personas.

23. The computer program product of claim 19, wherein the second component is configured to cause on the viewing screen separate display of effects of the plurality of settings for each of the plurality of personas.

24. The computer program product of claim 19, further including a third component to cause the logging of changes entered by each of the plurality of personas.

25. The computer program product of claim 19, further including a third component for displaying to the user a creation feature for the plurality of personas during an installation on the computing device or upon selection of an option feature.
